(19) United States
(12) Patent Application Publication
(10) Pub. No.: US 2007/0256454 A1
(43) Pub. Date: Nov. 8, 2007

(54) Method of reshaping a glass body

(75) Inventors: Anatoly Z. Rosenflanz, Maplewood, MN (US); Thomas J. Anderson, Cottage Grove, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/521,913

(22) Filed: Sep. 15, 2006

Related U.S. Application Data
(60) Provisional application No. 60/797,847, filed on May 3, 2006.

(51) Int. Cl. C03C 10/00; C03B 23/00

(52) U.S. Cl. 65/33.1; 65/102; 501/2

(57) ABSTRACT

A method for reshaping a glass body having a T_{g} and Tₓ by placing a glass body preform in a mold comprising a cavity having a void volume in the range of 70 to 130 percent of the volume of the glass body preform. The glass body preform is then heated at a temperature between (T_{g}) and (Tₓ+50 degrees Celsius) while applying pressure to the glass body preform to form a reshaped glass body.

### CROSS REFERENCE TO RELATED APPLICATION

This application claims the benefit of U.S. Provisional Patent Application No. 60/797,847, filed May 3, 2006, the disclosure of which is incorporated by reference herein in its entirety.

### FIELD OF INVENTION

The present invention relates generally to a method of reshaping glass. More particularly, the present invention relates to methods for reshaping a glass body having a T_{g} and Tₓ, wherein the difference between T_{g} and Tₓ is at least 5 degrees Celsius, by using a molding process.

### BACKGROUND

A large number of glass and glass-ceramic compositions are known. The majority of oxide glass systems utilize well-known glass-formers such as SiO₂, B₂O₃, P₂O₅, GeO₂, and TeO₂ to aid in the formation of the glass. Patent Cooperation Treaty Publication Number WO 2003/011776 and Rosenflanz et al., Bulk glasses and ultrahard nanoceramics based on alumina and rare-earth oxides, Nature 430, 761-64 (2004), report novel bulk glass compositions that can be formed by consolidating glass bodies (e.g., a plurality of glass beads) that exhibit T_{g} and Tₓ.

There is a continuing desire for new methods for forming glass and ceramic materials using these novel compositions.

### SUMMARY

The present invention relates generally to a method of reshaping glass. More particularly, the present invention relates to methods for reshaping a glass body having a T_{g} and Tₓ, wherein the difference between T_{g} and Tₓ is at least 5 degrees Celsius, by using a molding process. The glass to be reshaped is a monolith that does not require consolidation of multiple glass bodies to achieve the desired volume of glass (although the glass body preform to be reshaped may have been formed by a coalescing process). Providing a glass body preform with a volume that approximates the finished product volume (i.e., within 30%) can provide handling and processing improvements to the molder. For example, the glass body preform can be formed in a separate operation that focuses on the quality and consistency of the glass body preform (e.g., elimination of defects associated with coalescing operations). The molder may also be better equipped to handle glass body preforms of the approximate desired volume as compared to measuring and allocating a quantity of smaller glass bodies (e.g., beads) to mold the desired article.

In one aspect, the present invention provides a method of forming a molded article by placing a glass body preform in a mold comprising a cavity having a void volume in the range of 70 to 130 percent of the volume of the glass body preform. The glass body preform is then heated at a temperature between (T_{g}) and (Tₓ+50 degrees Celsius) while applying pressure to the glass body preform to form a reshaped glass body.

The glass body preform comprises a first metal oxide (e.g., Al₂O₃, Y₂O₃, ZrO₂, HfO₂, Ga₂O₃, REO, Bi₂O₃, MgO, Nb₂O₅, Ta₂O₅, CaO, transition metal oxides (i.e., oxides of Sc, Ti, V, Cr, Mn, Fe, Co, Ni, Cu, Zn), and complex metal oxides thereof) and a second metal oxide (e.g., Al₂O₃, Y₂O₃, ZrO₂, HfO₂, Ga₂O₃, REO, Bi₂O₃, MgO, Nb₂O₅, Ta₂O₅, CaO, transition metal oxides, and complex metal oxides thereof) wherein the first metal oxide and the second metal oxide are different from one another.

The glass body preform contains less than 20 (or 15, 10, 5, 3, 2, or even 1) percent by weight SiO₂, less than 20 (or 15, 10, 5, 3, 2, or even 1) percent by weight B₂O₃, and less than 40 (or 30, 20, 10, 5, 3, 2, or even 1) percent by weight P₂O₅, based on the total weight of the glass body preform. In some embodiments, the glass body preform comprises not more than 20 (or 15, 10, 8, 5, 3, 2, or 1) percent by weight collectively B₂O₃, CaO, GeO₂, P₂O₅, SiO₂, and TeO₂, based on the total weight of the glass body preform.

In another aspect, the present invention provides a method of forming a molded article by providing a plurality of glass bodies comprising a first metal oxide (e.g., Al₂O₃, Y₂O₃, ZrO₂, HfO₂, Ga₂O₃, REO, Bi₂O₃, MgO, Nb₂O₅, Ta₂O₅, CaO, transition metal oxides (i.e., oxides of Sc, Ti, V, Cr, Mn, Fe, Co, Ni, Cu, Zn), and complex metal oxides thereof) and a second metal oxide (e.g., Al₂O₃, Y₂O₃, ZrO₂, HfO₂, Ga₂O₃, REO, Bi₂O₃, MgO, Nb₂O₅, Ta₂O₅, CaO, transition metal oxides, and complex metal oxides thereof), wherein the first metal oxide and the second metal oxide are different from one another, wherein the glass bodies have a T_{g} and Tₓ, and wherein the difference between the T_{g} and the Tₓ of the glass bodies is at least 5 degrees Celsius, the glass bodies containing less than 20 (or 15, 10, 5, 3, 2, or even 1) percent by weight SiO₂, less than 20 (or 15, 10, 5, 3, 2, or even 1) percent by weight B₂O₃, and less than 40 (or 30, 20, 10, 5, 3, 2, or even 1) percent by weight P₂O₅. The plurality of glass bodies are then heated above the T_{g} and coalesced to provide a glass body preform. The glass body preform has a volume and a T_{g} and Tₓ, wherein the difference between T_{g} and Tₓ of the glass body preform is at least 5 degrees Celsius. The glass body preform is then heated at a temperature between (T_{g}) and (Tₓ+50 degrees Celsius) and pressure is applied to the glass body preform to form a reshaped glass body having a second shape. In the context of the present invention, the terms “first shape” and “second shape” in reference to the glass body preform and reshaped glass body, respectively, refer to the three-dimensional shape as well as the dimensions of the respective article. That is, if the glass body preform has a first shape that is a cylinder with a radius of 1 millimeter, and the reshaped glass body has a second shape that is a cylinder with a radius of 1.1 millimeter, the first and second shape are different from one another. In some aspects, the reshaped glass body is heat treated to form a glass-ceramic article. The ceramics (including glasses) of the present invention can be used in various applications where shaped ceramics are useful, including for example, metal working tools (e.g., abrasives, cutting tools, and cutting tool inserts), medical devices (surgical instruments, implants, dental restoratives, etc), optical elements, and structural components and wear parts (e.g., valve and bearing components).

In this application:

“amorphous material” refers to material derived from a melt and/or a vapor phase that lacks any long range crystal structure as determined by X-ray diffraction and/or has an exothermic peak corresponding to the crystallization of the amorphous material as determined by DTA (differential thermal analysis);

“ceramic” includes glass, crystalline ceramic, and combinations thereof;

“complex metal oxide” refers to a metal oxide comprising two or more different metal elements and oxygen (e.g., CeAl₁₁O₁₈, Dy₃Al₅O₁₂, MgAl₂O₄, and Y₃Al₅O₁₂);

“differential thermal analysis” or “DTA” refers to a procedure that involves measuring the difference in temperature between a sample and a thermally inert reference, such as Al₂O₃, as the temperature is raised. A graph of the temperature difference as a function of the temperature of the inert reference provides information on exothermic and endothermic reactions taking place in the sample. An exemplary instrument for performing this procedure is available from Netzsch Instruments, Selb, Germany under the trade designation “NETZSCH STA 409 DTA/TGA”. A suitable amount, e.g., 400 mg, of a sample can be placed in a suitable inert holder (e.g. a 100 ml Al₂O₃ sample holder) and heated in static air at a suitable rate, e.g. 10° C./minute, from an initial temperature (e.g. room temperature, or about 25° C.) to a final temperature, such as 1200° C.;

“glass” refers to amorphous material exhibiting a glass transition temperature;

“glass-ceramic” refers to ceramic comprising crystals formed by heat-treating glass;

“T_{g}” refers to the glass transition temperature as determined by DTA (differential thermal analysis);

“Tₓ” refers to the crystallization temperature as determined by DTA (differential thermal analysis); and

“rare earth oxides” or “REO” refers to cerium oxide (e.g., CeO₂), dysprosium oxide (e.g., Dy₂O₃), erbium oxide (e.g., Er₂O₃), europium oxide (e.g., Eu₂O₃), gadolinium oxide (e.g., Gd₂O₃), holmium oxide (e.g., Ho₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium oxide (e.g., Tb₂O₃), thorium oxide (e.g., Th₄O₇), thulium oxide (e.g., Tm₂O₃), and ytterbium oxide (e.g., Yb₂O₃), and combinations thereof.

Further, it is understood herein that unless it is stated that a metal oxide (e.g., Al₂O₃, complex Al₂O₃.metal oxide, etc.) is crystalline, for example, in a glass-ceramic, it may be glass, crystalline, or portions glass and portions crystalline. For example, if a glass-ceramic comprises Al₂O₃ and ZrO₂, the Al₂O₃ and ZrO₂ may each be in a glassy state, crystalline state, or portions in a glassy state and portions in a crystalline state, or even as a reaction product with another metal oxide(s) (e.g., unless it is stated that, for example, Al₂O₃ is present as crystalline Al₂O₃ or a specific crystalline phase of Al₂O₃ (e.g., alpha Al₂O₃), it may be present as crystalline Al₂O₃ and/or as part of one or more crystalline complex Al₂O₃.metal oxides).

The above summary of the present invention is not intended to describe each disclosed embodiment of every implementation of the present invention. The Figures and the detailed description that follow more particularly exemplify illustrative embodiments. The recitation of numerical ranges by endpoints includes all numbers subsumed with that range (e.g., 1 to 5 includes 1, 1.5, 2, 2.75, 3, 4, 4.80, and 5).

### BRIEF DESCRIPTION OF THE DRAWING

FIG. 1 is a perspective view of an exemplary molding apparatus useful in some embodiments of the present invention;

FIG. 2 is a perspective view of the exemplary molding apparatus shown in FIG. 1 having a glass body preform positioned in at least a portion of the mold cavity;

FIG. 3 is a perspective view of an exemplary glass body formed from the exemplary molding apparatus shown in FIG. 1 and a glass body preform having substantially the same volume as the mold cavity;

FIG. 4 is a perspective view of an exemplary glass body formed from the exemplary molding apparatus shown in FIG. 1 and a glass body preform having less volume than the mold cavity; and

FIG. 5 is a perspective view of an exemplary glass body formed from the exemplary molding apparatus shown in FIG. 1 and a glass body preform having more volume than the mold cavity.

These figures, which are idealized, are not to scale. The figures are intended to be merely illustrative of the present invention and are non-limiting.

### DETAILED DESCRIPTION

The present invention pertains to methods for reshaping glass to form bulk glass and glass-ceramic materials. The glass body that is to be reshaped is a glass monolith (i.e., single body) and is sometimes referred to as a “glass body preform” in the context of the present invention. The glass body preform comprises at least two metal oxides and has a T_{g} and Tₓ, wherein the difference between T_{g} and Tₓ is at least 5 degrees Celsius.

Patent Cooperation Treaty Publication Number WO 2003/011776 and Rosenflanz et al., Bulk glasses and ultrahard nanoceramics based on alumina and rare-earth oxides, Nature 430, 761-64 (2004), report novel glass compositions that can be used to form glass body preforms useful in the present invention, and are incorporated herein by reference. Glass body preforms useful in the present invention can also be obtained by other techniques, such as direct melt casting, melt atomization, containerless levitation, laser spin melting, and other methods known to those skilled in the art (see, e.g., Rapid Solidification of Ceramics, Brockway et al., Metals And Ceramics Information Center, A Department of Defense Information Analysis Center, Columbus, Ohio, January, 1984).

Metal oxides that may be used to form the glass body preform include, for example, Al₂O₃; TiO₂; rare earth oxides (REO's) such as CeO₂, Dy₂O₃, Er₂O₃, Eu₂O₃, Gd₂O₃, Ho₂O₃, La₂O₃, Lu₂O₃, Nd₂O₃, Pr₆O₁₁, Sm₂O₃, Tb₂O₃, Th₄O₇, Tm₂O₃ and Yb₂O₃; ZrO2, HfO₂, Ta₂O₅, Nb₂O₅, Bi₂O₃, WO₃, V₂O₅, Ga₂O₃, and alkaline earth metal oxides such as CaO and BaO. Examples of useful glass for carrying out the present invention include those comprising REO-TiO₂, REO-ZrO₂—TiO₂, REO-Nb₂O₅, REO-Ta₂O₅, REO-Nb₂O₅—ZrO₂, REO-Ta₂O₅—ZrO₂, CaO—Nb2O5, CaO—Ta2O5, BaO—TiO₂, REO-Al₂O₃, REO-Al₂O₃—ZrO₂, REO-Al₂O₃—ZrO₂—SiO₂, and SrO—Al₂O₃—ZrO₂ glasses. Useful glass formulations include those at or near a eutectic composition. In addition to these compositions and compositions disclosed in Patent Cooperation Treaty Publication Numbers WO 2003/011781, WO 2003/011776, WO 2005/061401, U.S. patent application having Ser. No. 11/273,513, filed Nov. 14, 2005 (Attorney Docket No. 61351US002), and Rosenflanz et al., Bulk glasses and ultrahard nanoceramics based on alumina and rare-earth oxides, Nature 430, 761-64 (2004), which are incorporated herein by reference, other compositions, including eutectic compositions, will be apparent to those skilled in the art after reviewing the present disclosure.

In some embodiments, the first and second metal oxides are each selected from the group consisting of Al₂O₃, Y₂O₃, ZrO₂, HfO₂, Ga₂O₃, REO, Bi₂O₃, MgO, Nb₂O₅, Ta₂O₅, CaO, transition metal oxides (i.e., oxides of Sc, Ti, V, Cr, Mn, Fe, Co, Ni, Cu, Zn), and complex metal oxides thereof).

In some instances, it may be preferred to incorporate limited amounts of oxides selected from the group consisting of: B₂O₃, CaO, GeO₂, SiO₂, TeO₂, and combinations thereof. These metal oxides, when used, are typically added in the range of 0 to 20% (or 0 to 15%, 0 to 10%, or even 0 to 5%) of the glass body preform depending, for example, upon the desired property.

In some embodiments, the glass body preform comprises at least 20 (in some embodiments, preferably at least 25, 30, 35, 40, 45, 50, 55, 60, 65, 70 or even at least 75) percent by weight Al₂O₃, based on the total weight of the glass body preform, and a metal oxide other than Al₂O₃ (e.g., Y₂O₃, ZrO₂, HfO₂, Ga₂O₃, REO, Bi₂O₃ MgO, Nb₂O₅, Ta₂O₅, CaO, transition metal oxides, and complex metal oxides thereof).

In some embodiments, the glass body preform comprises at least 20 (in some embodiments, preferably at least 25, 30, 35, 40, 45, 50, 55, 60, 65, 70 or even at least 75) percent by weight TiO₂, based on the total weight of the glass body preform, and a metal oxide other than (e.g., Al₂O₃, Y₂O₃, ZrO₂, HfO₂, Ga₂O₃, REO, Bi₂O₃, MgO, Nb₂O₅, Ta₂O₅, CaO, transition metal oxides, and complex metal oxides thereof).

In some embodiments, the glass body preform comprises at least 20 (in some embodiments, preferably at least 25, 30, 35, 40, 45, 50, 55, 60, 65, 70 or even at least 75) percent by weight Nb₂O₅, based on the total weight of the glass body preform, and a metal oxide other than Nb₂O₅ (e.g., Al₂O₃, Y₂O₃, ZrO₂, HfO₂, Ga₂O₃, REO, Bi₂O₃, MgO, Ta₂O₅, CaO, transition metal oxides, and complex metal oxides thereof).

In some embodiments, the glass body preform comprises at least 20 (in some embodiments, preferably at least 25, 30, 35, 40, 45, 50, 55, 60, 65, 70 or even at least 75) percent by weight Ta₂O₅, based on the total weight of the glass body preform, and a metal oxide other than Ta₂O₅ (e.g., Al₂O₃, Y₂O₃, ZrO₂, HfO₂, Ga₂O₃, REO, Bi₂O₃, MgO, Nb₂O₅, CaO, transition metal oxides, and complex metal oxides thereof).

Additional examples of useful compositions for carrying out this invention may be found in U.S. Pat. No. 2,150,694; Topol, L. E. et al, “Formation of new oxide glasses by laser spin melting and free fall cooling”, J. Non-Crystal. Solids 12, 377-390 (1973); Topol, L. E., “Formation of new lanthanide oxide glasses by laser spin melting and free-fall cooling”, J. Non-Crystall. Solids 15, 116-124 (1974); Shishido T., et al, in “Ln-M-O” glasses obtained by rapid quenching using laser beam, J. Mater. Sci. 13, 1006-1014 (1978); and Tatsumisago M. in “Infrared Spectra of Rapidly Quenched Glasses in the Systems, Li₂O—RO—Nb₂O₅ (R=Ba, Ca, Mg)” J. Amer. Ceram. Soc., 66 Vol. 2, 117-119 (1983).

In general, glasses that can be used to form glass body preforms of the present invention can be made by heating the appropriate metal oxide sources to form a melt, desirably a homogenous melt, and then cooling the melt to provide glass. Some embodiments of glass materials can be made, for example, by melting the metal oxide sources in any suitable furnace (e.g., an inductive heated furnace, a gas-fired furnace, or an electrical furnace), or, for example, in a flame or plasma. The resulting melt is cooled by discharging the melt into any of a number of types of cooling media such as high velocity air jets, liquids, graphite or metal plates (including chilled plates), metal rolls (including chilled metal rolls), metal balls (including chilled metal balls), and the like.

In one method, glasses that can be used to form glass body preforms of the present invention can be made utilizing flame fusion as disclosed, for example, in U.S. Pat. No. 6,254,981, incorporated by reference. Briefly, the metal oxide source materials are formed into particles sometimes referred to as “feed particles”. Feed particles are typically formed by grinding, agglomerating (e.g., spray-drying), melting, or sintering the metal oxide sources. The size of the feed particles fed into the flame generally determines the size of the resulting amorphous particle material. The feed particles are fed directly into a burner such as a methane-air burner, an acetylene-oxygen burner, a hydrogen-oxygen burner, and like. The materials are subsequently quenched in, for example, water, cooling oil, air, or the like.

Other techniques for forming melts, cooling/quenching melts, and/or otherwise forming glass include vapor phase quenching, plasma spraying, melt-extraction, gas or centrifugal atomization, thermal (including flame or laser or plasma-assisted) pyrolysis of suitable precursors, physical vapor synthesis (PVS) of metal precursors, and mechanochemical processing.

The cooling rate is believed to affect the properties of the quenched amorphous material. For instance, glass transition temperature, density and other properties of glass typically change with cooling rates. Rapid cooling may also be conducted under controlled atmospheres, such as a reducing, neutral, or oxidizing environment to maintain and/or influence the desired oxidation states, etc., during cooling. The atmosphere can also influence glass formation by influencing crystallization kinetics from undercooled liquid.

Glass body preforms of the present invention have been found to be moldable at temperatures above glass transition temperature. Glass body preforms useful in carrying out the present invention undergo glass transition (T_{g}) before significant crystallization occurs (Tₓ) as evidenced by the existence of an endotherm (T_{g}) at lower temperature than an exotherm (Tₓ). This allows for fabrication of articles of precise dimensions or near net shaped articles from glass body preforms. More specifically, for example, an article according to the present invention, can be provided by heating, for example, glass bodies (including beads, fibers, etc.) useful in carrying out the present invention above the T_{g} in a molding apparatus such that the glass bodies are reshaped. In certain embodiments, heating is conducted at least one temperature in a range of about 725° C. to about 1100° C.

For certain embodiments according to the present invention, reshaping may be conducted at temperatures up to 50 degrees Celsius higher than crystallization temperature (Tₓ). Although not wanting to be bound by theory, it is believed that the relatively slow kinetics of crystallization allow access to higher temperatures for viscous flow. In some embodiments, the reshaping is conducted at a temperature that does not exceed Tₓ.

During the reshaping process, the glass body preform is placed into the mold and between about 0.1 MPa and about 100 MPa (or between about 1 and 50 Mpa, or even between 3 Mpa and 25 Mpa) of pressure is applied at about between 500° C. and about 1100° C. (or between about 800° C. and 1000° C.) for between about 1 second and about 100 minutes to reshape the glass.

Once the desired shaped is formed, it can be removed from the mold. In some embodiments, a heat-treatment process is completed prior to removing the article from the mold. The heat-treatment partially crystallizes the glass to provide a glass-ceramic. In some embodiments, the heat-treatment temperature cycle directly follows the reshaping temperature cycle without an intervening cooling cycle. By heat-treating in the mold, shrinkage of the reshaped glass body caused by the heat-treatment can facilitate removal of the article from the mold. Such shrinkage is generally very small (i.e., typically less than 10%) and isotropic. In other embodiments, the reshaped glass body is heat treated after removal from the mold. Heat-treatment can be carried out in any of a variety of ways known to those skilled in the art.

In certain embodiments, the heat-treatment protocol may comprise at least two stages. The first stage comprising heating to a temperature near the first crystallization temperature (±50 degrees) of the glass and holding the temperature for at least 1 minute, 5 minutes, 20 minutes or even 1 hour to at least crystallize a portion of the glass. The second stage comprises heating at essentially any rate and encompassing temperatures higher than the first stage holding temperature. In some embodiments, the glass-ceramic can be cooled from the holding temperature of the first stage to about room temperature and then reheated in a second stage. In some embodiments, conducting heat-treatment in accordance with a two stage protocol has been found to reduce cracking and warpage of the article. In certain embodiments this target protocol is also beneficial for minimizing total heat-treatment time, thus improving manufacturability.

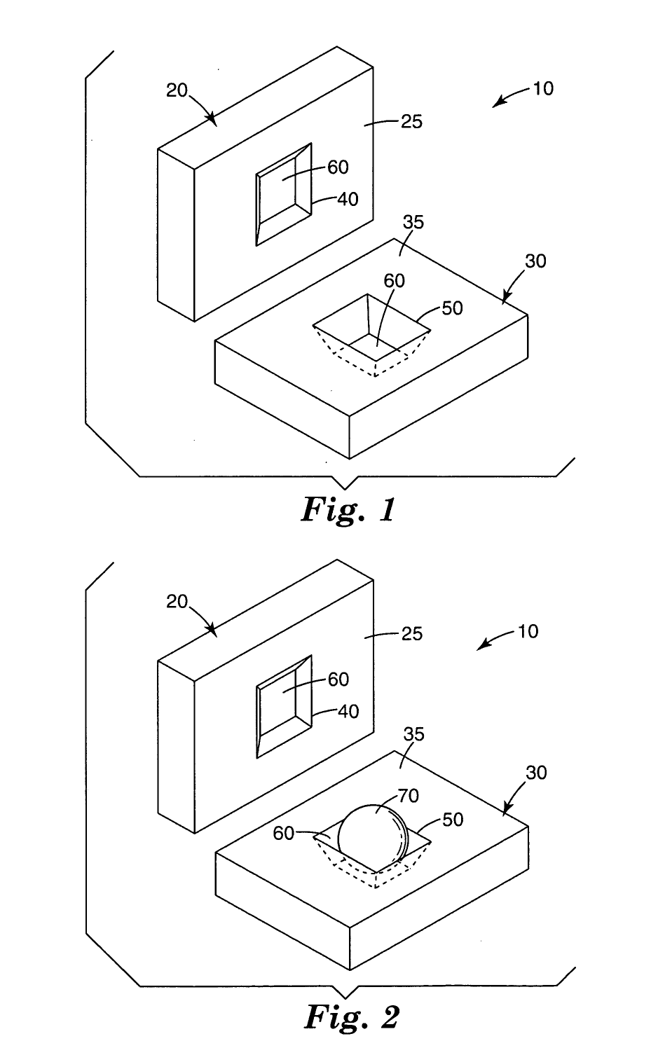

FIG. 1 is a perspective view of an exemplary molding apparatus useful in some embodiments of the present invention. As shown in FIG. 1, the mold apparatus 10 comprises a first mold portion 20 and a second mold portion 30. The first mold portion 20 has a mold surface 25 with a recessed portion 40, and the second mold portion 30 has a mold surface 35 with a recessed portion 50. When the mold surface 25 of the first mold portion 20 and the mold surface 35 of the second mold portion 30 are aligned and contacted, a cavity is formed having a void volume.

FIG. 2 is a perspective view of the exemplary molding apparatus shown in FIG. 1 with a glass body preform staged for reshaping. As shown in FIG. 2, the glass body preform 70 is positioned in at least a portion of the recessed portion 50 of the second mold portion 30. After inserting the glass body preform 70 in the mold apparatus 10, mold surface 25 and mold surface 35 are positioned opposite one another and a force is applied to maintain contact between the glass body preform 70 and each of the recessed portions 40, 50. The glass body preform 70 is then subjected to an elevated temperature above its T_{g}, but no more than 50 degrees Celsius above its Tₓ, while a force is applied to the molding apparatus 10 to force the mold surfaces 25, 35 toward one another. The elevated temperature and applied pressure cause the glass body preform to deform and generally assume the shape of the mold cavity 60.

The molding apparatus and the hot pressing equipment used to apply heat and pressure can be any variety known to those skilled in the art. In some embodiments, at least a portion of the surface of the mold is prepared to provide an optically smooth surface to the reshaped article using techniques known to those skilled in the art. In some embodiments, at least a portion of the surface of the mold imparts a pattern, small features, or desired surface finish to the reshaped article.

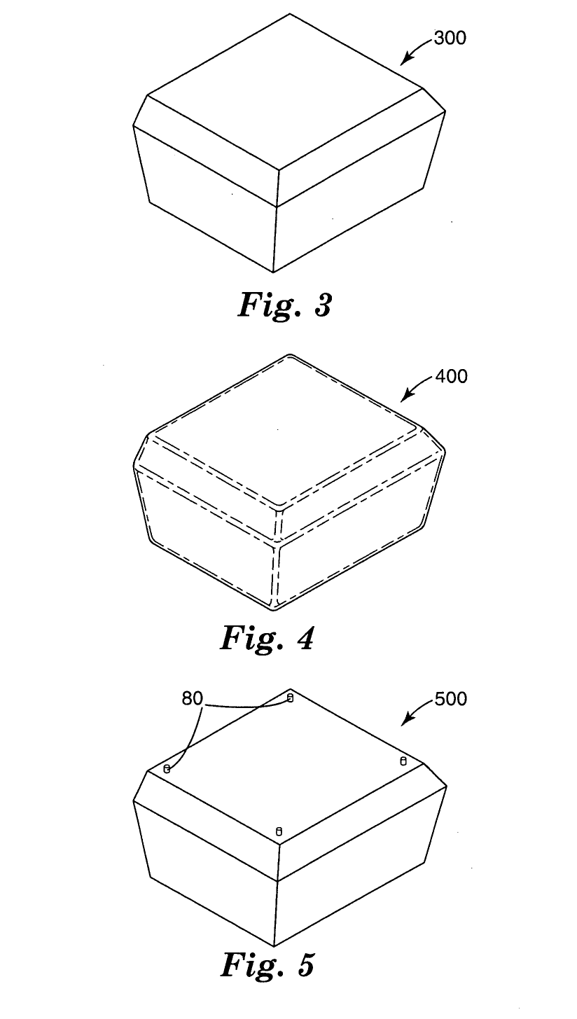

FIG. 3 is a perspective view of an exemplary glass body formed from the exemplary molding apparatus shown in FIG. 1. As shown in FIG. 3, the glass body 300 has assumed substantially the same shape as the mold cavity because the glass body preform had substantially the same volume as the mold cavity.

FIG. 4 is a perspective view of an exemplary glass body formed from the exemplary molding apparatus shown in FIG. 1 wherein the glass body preform had less volume than the mold cavity. As shown in FIG. 4, the reshaped glass body 400 assumed the same general shape of the mold cavity, but all of the outer edges contain radii due to the volume difference between the glass body preform and the mold cavity.

To achieve the desired reshaping of the present invention, the void volume of the mold cavity is in the range of 70 to 130 percent of the volume of the glass body preform. In some embodiments, the void volume of the mold cavity is at least 75 (or 80, 85, 90, 95, or even 100) percent of the volume of the glass body. In other embodiment, the void volume of the mold cavity is 105 (or 110, 115, 120, 125, or even 130) percent of the volume of the glass body. In some embodiments, the volume of the glass body preform and the void volume of the mold cavity are substantially equal (i.e., less than 3% difference).

FIG. 5 is a perspective view of an exemplary glass body formed from the exemplary molding apparatus shown in FIG. 1 and a glass body preform having more volume than the mold cavity. As shown in FIG. 5, the reshaped glass body 500 contains flash 80. In the context of the present invention, the term “flash” refers to any excess material that is formed with and attached to the reshaped glass body and is present only because of limitations in the molding process, and is otherwise undesirable. In some embodiments, the flash is removed in a subsequent operation, such as, for example, a machining operation. In other embodiments, it is not necessary to remove the flash prior to utilizing the reshaped glass body.

In the context of the present invention, the term “void volume” of the cavity refers to the total volume of the cavity as determined when the portions of the mold (i.e., the components of the mold that move relative to one another to “open” and “close” the mold, or otherwise apply pressure to the glass body preform), are at their most intimate position achieved when reshaping the glass body preform, less any “cavity port volume”. The term “cavity port volume” refers to any void feature in fluid communication with the cavity, such as, for example, holes, channels, slots, parting spaces, or other voids that do not effect the desired shape of the reshaped glass body except to the extent that the features correspond with flash. The features that make up the cavity port volume may exist for a number of reasons, including, for example, to transfer gases into or out of the mold, as passages for ejectors, or as flash volume for excess preform glass material.

In another aspect, the present invention provides a method of forming a molded article by providing a plurality of glass bodies comprising a first metal oxide and a second metal oxide, wherein the first metal oxide and the second metal oxide are different from one another, wherein the glass bodies have a T_{g} and Tₓ, and wherein the difference between the T_{g} and the Tₓ of the glass bodies is at least 5 degrees Celsius, the glass bodies containing less than 20% by weight SiO₂, less than 20% by weight B₂O₃, and less than 40% by weight P₂O₅. The plurality of glass bodies are then heated above the T_{g} and coalesced to provide a glass body preform. The glass body preform has a volume has a T_{g} and Tₓ, wherein the difference between T_{g} and Tₓ of the glass body preform is at least 5 degrees Celsius. The glass body preform is then heated at a temperature between (T_{g}) and (Tₓ+50 degrees Celsius) and pressure is applied to the glass body preform to form a reshaped glass body having a second shape. Optionally, the preform glass body in this aspect of the present invention can be reshaped with a mold cavity having a void volume in the range of 70 to 130 percent of the volume of the glass body preform.

The shape of the glass body preform can be any geometric shape. In some embodiments the glass body preform is substantially spheroidal shaped and has an aspect ratio in the range of 1.0 to 1.4. In some embodiments, the glass body preform approximates the shape of the desired reshaped article to reduce the amount of reshaping that must occur. In some embodiments, multiple reshaping operations are conducted to achieve the desired shape. In yet further embodiments, additional glass body preform can be added during a shaping or reshaping process to prepare articles with regions that vary in properties (e.g., color, composition, crystallinity, hardness, transparency, etc.). The regions can represent layers or discrete portions within the finished article.

The methods of the present invention can be used to reshape small or large glass body preforms. In some embodiments, the glass body preforms are smaller than 1 mm³, in other embodiments, the glass body preforms are larger than 1 (or even 10, 100, or 1,000) mm³.

In some embodiments, the methods of the present invention can be used to form an array of reshaped glass bodies (e.g., at least a two by two matrix) that can be reshaped in either a batch or continuous process. The array of cavities used to form the array of reshaped glass bodies can optionally be connected to one another to form a connected array of reshaped glass bodies.

Advantages and other embodiments of this invention are further illustrated by the following examples, but the particular materials and amounts thereof recited in these examples, as well as other conditions and details, should not be construed to unduly limit this invention. For example, the shapes of the reshaped article and the composition of the glass body preforms can vary.

### EXAMPLES

TABLE 1
Materials used to create Examples 1–23.

| Material | Source |
|---|---|
| alumina (Al₂O₃) powder | Condea Vista, Tucson, AZ under the trade |
| | designation “APA-0.5” |
| calcium oxide (CaO) powder | Alfa Aesar, Ward Hill, MA |
| erbium nitrate pentahydrate (ErNo₃.5H₂O) | Aldrich Chemical, Milwaukee, WI |
| lanthanum oxide (La₂O₃) powder, calcined | Molycorp Inc., Mountain Pass, CA |
| at 700° C. for 6 hours | |
| tantalum oxide (Ta₂O₅) powder | Aldrich Chemical, Milwaukee, WI |
| niobium oxide (Nb₂O₅) powder | Aldrich Chemical, Milwaukee, WI |
| zirconium oxide (ZrO₂) powder | Zirconia Sales, Inc., Marietta, GA under |
| | the trade designation “DK-1” |
| zirconium oxide (ZrO₂) powder with a | Zirconia Sales, Inc., Marietta, GA under |
| nominal composition of 100 wt-% ZrO₂(+HfO₂) | the trade designation “DK-2” |
| gadolinium oxide (Gd₂O₃) powder | Molycorp Inc., Mountain Pass, CA |
| titanium dioxide particles (TiO₂) | Kemira Inc., Savannah, GA |
| barium oxide particles (BaO) | Aldrich Chemical, Milwaukee, WI |
| yttrium oxide (Y₂O₃) powder | Molycorp Inc., Mountain Pass, CA |
| milling media, 10 mm diameter, 99% | Union Process, Akron, OH |
| alumina | |
| zirconia milling media, 5 mm diameter | Tosoh Co., Japan |
| spheres | |

### Example 1

Example 1 illustrates that directly-cooled glass according to present invention can be press-molded into articles when heated to a temperature above T_{g}.

A polyethylene bottle was charged with 132.36 grams (g) of alumina powder, 122.64 grams of lanthanum oxide powder, 45 grams of zirconium oxide powder, and 150.6 grams of distilled water. About 450 grams of alumina milling media was added to the bottle, and the mixture was milled at 120 revolutions per minute (rpm) for 4 hours to thoroughly mix the ingredients. After the milling, the milling media were removed and the slurry was poured onto a glass (“PYREX”) pan where it was dried using a heat gun. The dried mixture was ground with a mortar and pestle and screened through a 70-mesh screen (212-micrometer opening size).

A small quantity of the dried particles was melted in an arc discharge furnace (Model No. 5T/A 39420; from Centorr Vacuum Industries, Nashua, N.H.). About 1 gram of the dried and sized particles was placed on a water-chilled copper plate located inside the furnace chamber. The furnace chamber was evacuated and then backfilled with argon gas at 13.8 kilopascals (kPa) (2 pounds per square inch (psi)) pressure. An arc was struck between an electrode and a plate. The temperatures generated by the arc discharge were high enough to quickly melt the dried and sized particles. After melting was complete, the material was maintained in a molten state for about 10 seconds to homogenize the melt. The resultant melt was rapidly cooled by shutting off the arc and allowing the melt to cool on its own. Rapid cooling was ensured by the small mass of the sample and the large heat sinking capability of the water-chilled copper plate. The resulting fused material was removed from the furnace within one minute after the power to the furnace was turned off. Although not wanting to be bound by theory, it is estimated that the cooling rate of the melt on the surface of the water chilled copper plate was above 100° C./second. The fused material was in the form of transparent glass beads. The largest diameter of any of the beads was measured at 2.8 millimeters.

Several of the transparent glass beads were placed on top of cylindrical cavities (1 mm diameter and 3 mm deep) machined out of a graphite plate (one glass bead per cavity). Another flat graphite plate was placed on top of the beads and the whole assembly was placed inside a graphite heating-element hot-press. A 20 kg load was applied to the top plate. The assembly including the glass beads was heated in nitrogen at 900° C. for 10 min. It was observed that the glass beads underwent viscous flow during the heating and completely filled the cavities with a small amount of flash and assumed a cylindrical shape. After cooling, the glass cylinders were removed from the graphite molds.

### Examples 2 Through 22

Examples 2-22 illustrate the formation of glass compositions exhibiting both T_{g} and Tₓ.

For each example, a polyethylene bottle was charged with 100 g of the compositions described in Table 2. About 400 g of zirconia milling media was added to the bottle along with 100 ml distilled and deionized water and the contents were milled for 24 hrs. at 120 rpm. The milling media was dried in a glass pan using a heat gun. Prior to melting in a flame, the dried particles were calcined at 1300 C for 1 hr. in air in an electrically-heated furnace.

After grinding with a mortar and pestle, a portion of the ground, calcined particles was fed into a hydrogen/oxygen torch flame to generate melted glass beads. The torch used to melt the particles was a Bethlehem bench burner “PM2D Model B”, obtained from Bethlehem Apparatus Co., Hellertown, Pa. The flows of hydrogen and oxygen were set at the following rates. For the inner ring, the hydrogen flow rate was 8 standard liters per minute (SLPM) and the oxygen flow rate was 3 SLPM. For the outer ring, the hydrogen flow rate was 23 (SLPM) and the oxygen flow rate was 9.8 SLPM. The dried and sized particles were fed directly into the torch flame, where they were melted and transported to an inclined stainless steel surface (approximately 51 centimeters (20 inches) wide inclined at an angle of 45 degrees) with cold water running (approximately 8 liters/minute) over the surface to form quenched beads.

The resulting quenched beads were collected in a pan and dried at 110 C. The beads were substantially spherical in shape and ranged in size from a few tens of micrometers to up to 250 micrometers. From the fraction of beads measuring between 125 micrometers to 150 micrometers, greater than 95% were clear when viewed by an optical microscope.

To measure T_{g} and Tₓ for the examples, differential thermal analysis (DTA) was employed. Each example was screened to retain beads in the 90-125 micrometer size range. DTA runs were made (using an instrument obtained from Netzsch Instruments, Selb, Germany under the trade designation “NETZSCH STA 409 DTA/TGA”). The amount of each screened sample placed in a 100-microliter Al₂O₃ sample holder was 400 milligrams. Each sample was heated in static air at a rate of 10° C./minute from room temperature (about 25° C.) to 1200° C.

The T_{g} and Tₓ values for Examples 2 through 22 are reported in Table 2. Some examples in Table 2 exhibited two crystallization events during the DTA scan. In these cases, Tₓ values for each event is shown.

TABLE 2

| | Oxide content, weight % | | | | | | | | | | | T_{g}, | Tₓ, |
|---|---|---|---|---|---|---|---|---|---|---|---|---|---|
| Example | La₂O₃ | Gd₂O₃ | Y₂O₃ | Al₂O₃ | ZrO₂ | TiO₂ | BaO | Nb₂O₅ | Ta₂O₅ | Er₂O₃ | CaO | ° C. | ° C. |
| 2 | 42.29 | | | 38.98 | 18.73 | | | | | | | 831 | 935 |
| 3 | | 45.30 | | 42.70 | 12.00 | | | | | | | 859 | 931 |
| 4 | | | 28.70 | 52.70 | 18.60 | | | | | | | 872 | 937 |
| 5 | 48.10 | | | 51.90 | | | | | | | | 830 | 936 |
| 6 | | 51.50 | | 48.50 | | | | | | | | 857 | 932 |
| 7 | | | 34.00 | 66.00 | | | | | | | | 870 | 934 |
| 8 | 21.25 | | | 8.36 | | | | 69.36 | | 1.02 | | 696 | 781, |
| | | | | | | | | | | | | | 937 |
| 9 | 18.62 | | | 19.59 | | | | 60.78 | | 1.00 | | 725 | 802, |
| | | | | | | | | | | | | | 937 |
| 10 | 26.10 | | | 7.31 | | | | 65.6 | | 1.00 | | 707 | 797 |
| 11 | 48.41 | | | 5.07 | | | | 45.51 | | 1.00 | | ~805 | 848 |
| 12 | 21.94 | | | 23.62 | | | | 53.42 | | 1.02 | | ~705 | 802.9 |
| 13 | 14.51 | | | 5.71 | | | | | 78.75 | 1.02 | | 842 | 942 |
| 14 | 13.23 | | | 13.93 | | | | | 71.83 | 1.00 | | ~815 | 896, |
| | | | | | | | | | | | | | 1079 |
| 15 | 18.14 | | | 5.08 | | | | | 75.78 | 1.00 | | 875 | 979.9 |
| 16 | 37.11 | | | 3.89 | | | | | 58.00 | 1.00 | | 840 | 923, |
| | | | | | | | | | | | | | 982 |
| 17 | 27.56 | | | 29.68 | | | | | 41.77 | 1.00 | | 840 | 934 |
| 18 | 16.16 | | | 17.40 | | | | | 65.43 | 1.00 | | 850 | 891 |
| 19 | 21.04 | | | 19.18 | 9.28 | | | | 44.55 | 1.00 | 4.95 | 840 | 939 |
| 20 | 45.00 | | | | | 55.00 | | | | | | 799 | 875 |
| 21 | 36.00 | | | | 20.00 | 44.00 | | | | | | 821 | 876 |
| 22 | | | | | | 52.50 | 47.50 | | | | | 724 | 760 |

### Example 23

Example 23 illustrates a process by which a previously-molded glass article can be altered by a secondary molding step and subsequently converted to a glass-ceramic article.

A polyethylene bottle was charged with 43 g La₂O₃, 38.5 g Al₂O₃ and 18.5 g ZrO₂. About 180 g of isopropyl alcohol and 200 g zirconia milling media was added to the bottle and the contents were milled, dried and ground as described for Example 2. The resulting particles were screened through a 70-mesh screen (212 micrometer opening).

Glass beads were formed as described for Example 2. 15 g of beads sized between 90 micrometers and 125 micrometers was placed in a graphite die having a 25 mm diameter cavity and hot-pressed at 925 C into a glass body preform. After hot-pressing, the preform was removed from the die. Subsequently, the preform was sectioned into chunks. One such chunk (about 9 mm in diameter and 4 mm in thickness) was placed into a tungsten carbide mold with a 1 cm diameter circular cavity having an optically-smooth finish. The mold was configured such that one portion of the mold was a hollow cylinder with a solid bottom, and the other portion of the mold was a solid cylinder that dimensioned to fit within the hollow cylinder. During the reshaping process, the final positions of the two portions relative to one another (i.e., the most intimate position they achieve during reshaping) was determined by the volume of the glass body preform. The resulting reshaped glass article had a cylindrical shape with sharp corners at the two end surfaces. Accordingly, the void volume of the mold cavity was approximately equal to the volume of the glass body preform. The assembly including the glass body preform chunk was reheated to 925 C, press-molded to shape, cooled, and demolded. The resulting newly-shaped glass article had optically smooth surfaces, replicating the surface of the mold.

Further heat-treatment at 1200 C for one hour crystallized the glass article into a glass-ceramic article. Even after crystallization treatment, the article's surfaces remained optically smooth.

It is to be understood that even in the numerous characteristics and advantages of the present invention set forth in above description and examples, together with details of the structure and function of the invention, the disclosure is illustrative only. Changes can be made to detail, especially in matters of shape, size and arrangement of the molding apparatus within the principles of the invention to the full extent indicated by the meaning of the terms in which the appended claims are expressed and the equivalents of those structures and methods.

What is claimed is:

1. A method of forming a molded article comprising:
providing a glass body preform having a volume and a first shape, the glass body preform comprising a first metal oxide and a second metal oxide, wherein the first metal oxide and the second metal oxide are different from one another, the glass body preform comprising a T_{g} and Tₓ, wherein the difference between T_{g} and Tₓ is at least 5 degrees Celsius, and wherein the glass body preform contains less than 20% by weight SiO₂, less than 20% by weight B₂O₃, and less than 40% by weight P₂O₅, based on the total weight of the glass body preform;
providing a mold comprising a cavity having a void volume in the range of 70 to 130 percent of the volume of the glass body preform;
placing at least a portion of the glass body preform within the void volume of the mold;
heating the glass body preform at a temperature between (T_{g}) and (Tₓ+50 degrees Celsius) and applying pressure to the glass body preform to form a reshaped glass body having a second shape.

2. The method of claim 1 wherein the first metal oxide is selected from the group consisting of Al₂O₃, Y₂O₃, ZrO₂, HfO₂, Ga₂O₃, REO, Bi₂O₃, MgO, Nb₂O₅, Ta₂O₅, CaO, transition metal oxides, and complex metal oxides thereof.

3. The method of claim 2 wherein the second metal oxide is selected from the group consisting of Al₂O₃, Y₂O₃, ZrO₂, HfO₂, Ga₂O₃, REO, Bi₂O₃, MgO, Nb₂O₅, Ta₂O₅, CaO, transition metal oxides, and complex metal oxides thereof.

4. The method of claim 3 wherein the glass body preform comprises not more than 20 percent by weight collectively B₂O₃, CaO, GeO₂, SiO₂, TeO₂, and combinations thereof, based on the total weight of the glass body preform.

5. The method of claim 1 further comprising heat-treating the reshaped glass body in the mold to provide a glass-ceramic article.

6. The method of claim 1 further comprising removing the reshaped glass body from the mold and subsequently heat-treating the reshaped glass body to provide a glass-ceramic article.

7. The method of claim 1 wherein the first shape is substantially spherical and has an aspect ratio in the range of 1.0 to 1.4.

8. The method of claim 1 wherein the void volume of the cavity is at least 10 mm³.

9. The method of claim 1 wherein the cavity in the mold has a void volume in the range of 90 to 105 percent of the volume of the glass body preform.

10. The method of claim 1 wherein the mold further comprises at least one cavity port in fluid connection with the cavity.

11. A molded article made according to the method of claim 1.

12. A method of forming a molded glass-ceramic article comprising:
providing a glass body preform having a volume and a first shape, the glass body preform comprising Al₂O₃, and a second metal oxide selected from the group consisting of Y₂O₃, ZrO₂, HfO₂, Ga₂O₃, REO, Bi₂O₃, MgO, Nb₂O₅, Ta₂O₅, CaO, transition metal oxides, and complex metal oxides thereof, the glass body preform comprising a T_{g} and Tₓ, wherein the difference between T_{g} and Tₓ is at least 5 degrees Celsius, and wherein the glass body preform contains less than 20% by weight SiO₂, less than 20% by weight B₂O₃, and less than 40% by weight P₂O₅, based on the total weight of the glass body preform;
providing a mold comprising a cavity having a void volume in the range of 70 to 130 percent of the volume of the glass body preform;
placing at least a portion of the glass body preform within the void volume of the mold;
heating the glass body at a temperature between (T_{g}) and (Tₓ+50 degrees Celsius) and applying pressure to the glass body preform to form a reshaped glass body having a second shape;
heat-treating the reshaped glass body to form a glass-ceramic article; and
removing the glass-ceramic article from the mold.

13. The method of claim 12 wherein the glass body preform comprises not more than 20 percent by weight collectively B₂O₃, CaO, GeO₂, SiO₂, TeO₂, and combinations thereof, based on the total weight of the glass body preform.

14. The method of claim 12 wherein the first shape is substantially spheroidal and has an aspect ratio in the range of 1.0 to 1.4.

15. The method of claim 12 wherein the void volume of the cavity is at least 10 mm³.

16. The method of claim 12 wherein the cavity in the mold has a void volume in the range of 90 to 105 percent of the volume of the glass body preform.

17. A method of forming a molded article comprising:
providing a plurality of glass bodies comprising a first metal oxide and a second metal oxide, wherein the first metal oxide and the second metal oxide are different from one another, wherein the glass bodies have a T_{g} and Tₓ, and wherein the difference between the T_{g} and the Tₓ of the glass bodies is at least 5 degrees Celsius, the glass bodies containing less than 20% by weight SiO₂, less than 20% by weight B₂O₃, and less than 40% by weight P₂O₅;
heating the glass above the T_{g} and coalescing at least a portion of the first plurality of particles to provide a glass body preform having a volume and a first shape, the glass body preform having a T_{g} and Tₓ, wherein the difference between T_{g} and Tₓ of the glass body preform is at least 5 degrees Celsius;
heating the glass body preform at a temperature between (T_{g}) and (Tₓ+50 degrees Celsius) and applying pressure to the glass body preform to form a reshaped glass body having a second shape.

18. The method of claim 17 wherein the first metal oxide is selected from the group consisting of Al₂O₃, Y₂O₃, ZrO₂, HfO₂, Ga₂O₃, REO, Bi₂O₃, MgO, Nb₂O₅, Ta₂O₅, CaO, transition metal oxides, and complex metal oxides thereof.

19. The method of claim 17 wherein the glass body preform comprises not more than 20 percent by weight collectively B₂O₃, CaO, GeO₂, SiO₂, TeO₂, and combinations thereof, based on the total weight of the glass body preform.

20. The method of claim 17 further comprising providing a mold comprising a cavity having a void volume in the range of 70 to 130 percent of the volume of the glass body preform, and placing at least a portion of the glass body preform within the void volume of the mold.
